(19) United States
(12) Patent Application Publication
(10) Pub. No.: US 2007/0153093 A1
(43) Pub. Date: Jul. 5, 2007

(54) Apparatus and method for image capturing with an image scaling unit to scale a portion of an image

(75) Inventors: Yen-Yu Lin, Jhubei City (TW); Tien-Yu Chang, Jhongli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/322,499

(22) Filed: Dec. 30, 2005

(51) Int. Cl. H04N 5/228

(52) U.S. Cl. 348/222.1

(57) ABSTRACT

An apparatus for image capturing includes a sensing device, an image processing unit, an image scaling unit, and a memory device. The sensing device is for capturing an image, and the image processing unit is for processing the image. The memory device is for storing the portion of the image, and the image scaling unit is for scaling the portion of the image. After the image processing unit processes the image, only the portion of the image is stored in the memory device to be transmitted to the image scaling unit for image scaling.

### BACKGROUND OF THE INVENTION

1. Field of the Invention

The invention relates in general to an apparatus and method for image capturing, and more particularly to an apparatus and method for two-pass image capturing.

2. Description of the Related Art

FIG. 1 illustrates a block diagram of a conventional image capturing system. The image capturing system 100 includes a camera 110, an image signal processor (ISP) 120, an image resizer 130, a JPEG codec 140, a central processing unit (CPU) 150, a first memory device 160, and a second memory device 170. The image M captured by the camera 110 is transmitted to the ISP 120 where an image processing is performed on the image M to output image data Di corresponding to a digital zoom-in area S of the image M. The image resizer 130 performs a scaling operation on the image data Di to enlarge the digital zoom-in area S of the image M so as to generate an image M′ having the same scale as the image M, and outputs the scaled image data Ds. The JPEG codec 140 encodes the scaled image data Ds to have a JPEG format and store the encoded image data De into the first memory device 160, such as a NOR flash. Besides, the CPU 150 transmits the encoded image data De to the second memory device 170 for storing, which may be a NAND flash or a memory card.

For example, the zoom-in area S is located in the center of the image M and is a half of the image M in width and length as shown in FIG. 1. The image resizer 130 is used to enlarge the zoom-in area S twice respectively in width and length to form the image M′. Referring to FIG. 2, a schematic diagram of the magnification of the zoom-in area S to form the image M′ by an interpolation method is shown. In terms of horizontal magnification, a pixel row R′ of the image M′ is generated by interpolating a pixel P′ (denoted by a dotted grid) into every two adjacent pixels P in a pixel row R of the zoom-in area S. In terms of vertical magnification, a pixel row R″ (denoted by a slash grid) of the image M′ is generated by interpolating a pixel P″ into each two corresponding pixels P (or P′) respectively on two adjacent pixel rows R′ of the image M′. Owing that two adjacent pixel rows R′ are needed for magnifying the zoom-in area S vertically, the image resizer 130 has to use a line buffer 132 for storing the corresponding image data of pixel rows as reference. A better interpolation method may require more pixel rows R′ as reference and thus a larger line buffer 132 has to be provided to store these pixel data.

However, in the application of a high resolution and high digital zoom-in rate, the image resizer 130 may not generate the required pixel rows R″ in time when a pixel row R of the zoom-in area S is inputted from the ISP 120. If the line buffer 132 is not large enough, the image data inputted to the image resizer 130 from the ISP 120 will be lost for the resizer 130 cannot process the image data in time. For example, the service ratio of the resizer 130 is 2, that is, two pixel rows are generated by the resizer 130 as one pixel row R is inputted from the ISP 120. Assume the target of image magnification is to enlarge the image from 640×480 pixels to 1920×1440 pixels (3 times in size), then the amount of pixels P which should be stored in the line buffer 132 is ((1440−480×2)/3)×640=102400. If for each pixel P, it requires 8 bits for storing each of Y, U, V values, then the required memory size of the line buffer 132 is 102400×8×3=2457600 bit (˜2.5 Mb). Due to performance consideration, the line buffer 132 should be on-chip memory, thereby increasing cost of the image capturing system 100.

### SUMMARY OF THE INVENTION

It is therefore an object of the invention to provide an apparatus and method for image capturing. Image data corresponding to a portion of the image is stored without image scaling in the first pass operation, while the stored image data are read and scaled to a predetermined scale in the second pass operation. By using the two-pass method, the invention can solve the data-loss issue occurred in the prior art.

The invention achieves the above-identified object by providing an apparatus for image capturing. The apparatus for image capturing includes a sensing device, an image processing unit, an image scaling unit, and a memory device. The sensing device is for capturing an image, and the image processing unit is for processing the captured image. The image scaling unit is coupled to the image processing unit for scaling a portion of the image, and the memory device is for storing the portion of the image. The image processing unit processes the image, and a portion of the image is stored in the memory device, and then the portion of the image stored in the memory device is transmitted to the image scaling unit for image scaling.

The invention achieves the above-identified object by providing a method for image capturing. The method for image capturing includes capturing an image; storing a portion of the image; and scaling the portion of the image.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a block diagram of a conventional image capturing system.

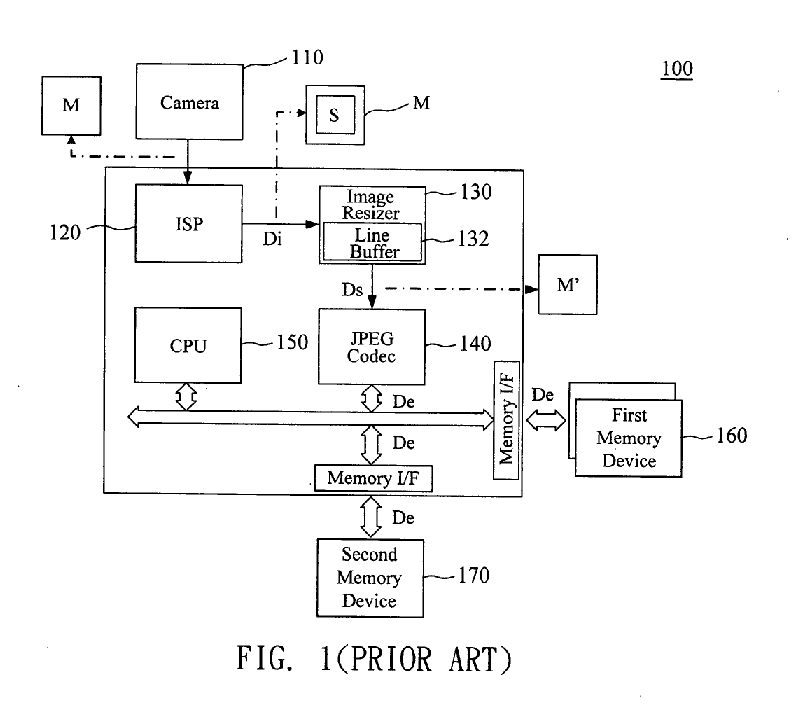

FIG. 2 is a schematic diagram of the magnification of the zoom-in area to form the image by an interpolation method.

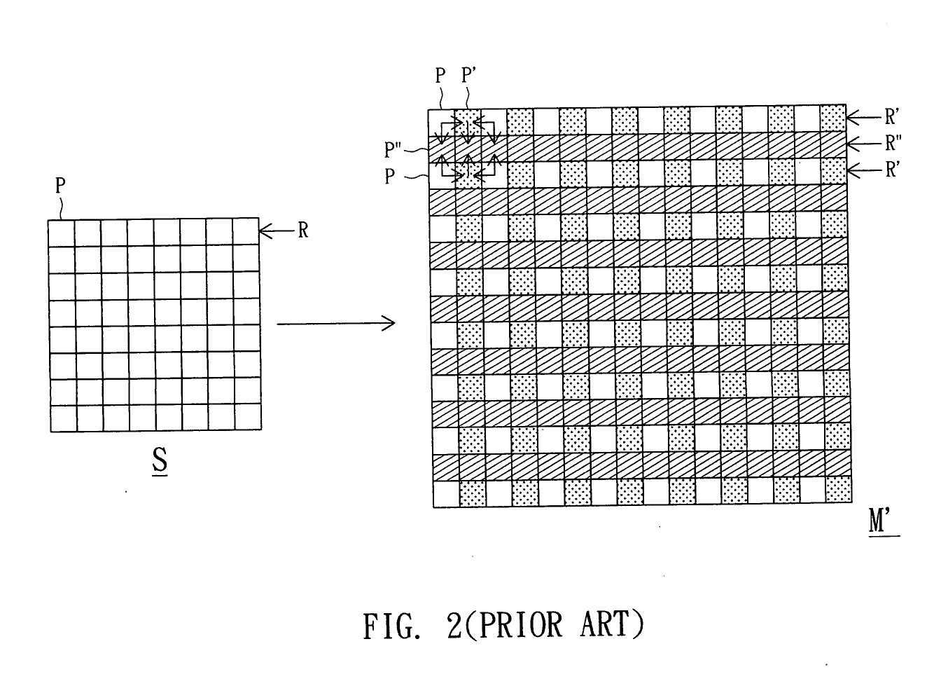

FIG. 3 is a block diagram of an image capturing apparatus according to a preferred embodiment of the invention.

FIG. 4 is a flow chart of the method for image capturing according to the preferred embodiment of the invention.

FIG. 5A is a block diagram of the image capturing apparatus performing the first pass operation.

FIG. 5B is a block diagram of the image capturing apparatus performing the second pass operation.

FIG. 5C is a block diagram of the image capturing apparatus transmitting the image data from the first memory device to the second memory device.

### DETAILED DESCRIPTION OF THE INVENTION

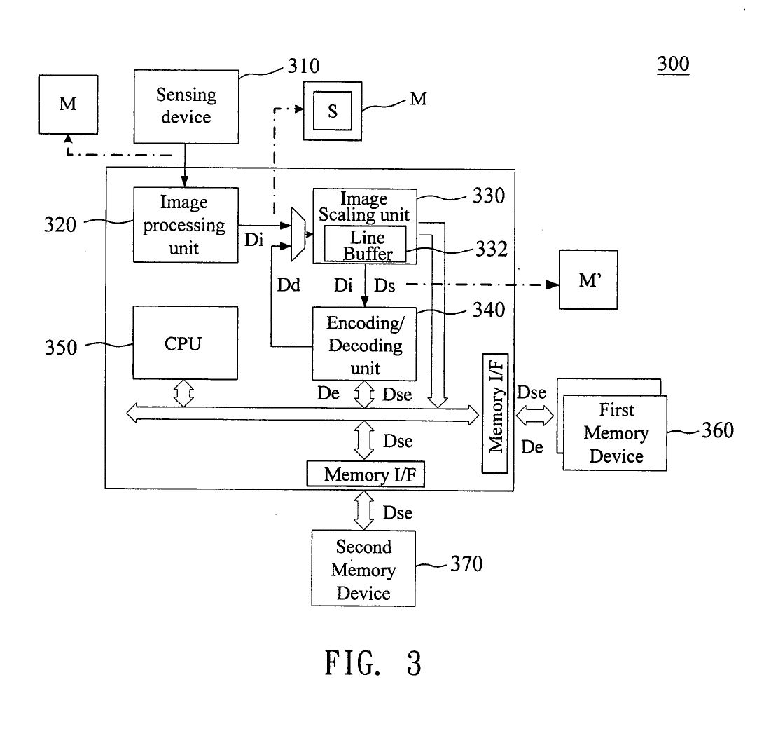

Referring to FIG. 3, a block diagram of an image capturing apparatus according to a preferred embodiment of the invention is shown. The image capturing apparatus 300 includes a sensing device 310, an image processing unit 320, an image scaling unit 330, an encoding/decoding unit 340, a CPU 350, a first memory device 360, and a second memory device 370. The sensing device 310 is, for example, a camera having a coupled charge device (CCD) or a complimentary metal oxide semiconductor (CMOS) sensor. The sensing device 310 is for capturing an image M. The image processing unit 320, such as an ISP, is for processing the image M and outputting image data Di. It should be noted that the image processing unit 320 may only process a portion of the image, such as a zoom-in area S of the image M. The image scaling unit 330, such as an image resizer, is coupled to the image processing unit 320 for receiving the image data Di.

The encoding/decoding unit 340, such as a half-duplex or a full-duplex JPEG codec, is coupled to the image scaling unit 330 for encoding the image data Di received from the image processing unit 320 into a specific image format, such as a JPEG format, and outputting the encoded image data De to the first memory device 360 for storing. The first memory device 360 may include a NOR flash and random access memory (RAM) for instance. The second memory device 370 may be a NAND flash or a memory card. The encoding/decoding unit 340 is further used to decode the encoded image data De from the first memory device 360 and transmit the decoded image data Dd to the image scaling unit 330.

In a first pass of operation, the image data Di is directly transmitted to the encoding/decoding unit 340 for data encoding via the image scaling unit 330, and the encoded image data De are then stored in the first memory device 360. In a second pass of operation, the image data De stored in the first memory device 360 are decoded by the encoding/decoding unit 340 and the decoded image data Dd are transmitted to the image scaling unit 330 for scaling, where the zoom-in area S of the image M is enlarged to be an image M′, which has the same scale as the image M for instance. The scaled image data Ds corresponding to the image M′ is transmitted to the encoding/decoding unit 340 for encoding and the scaled and encoded image data Dse are then stored in the first memory device 360.

The CPU 350 transmits the scaled and encoded image data Dse to the second memory device 370 for storing, which may be, as mentioned, a NAND flash, a memory card, or a micro drive. Furthermore, the image scaling unit 330 includes a line buffer 332 for storing the image data Dd which is transmitted to the image scaling unit 330 in the second pass of operation.

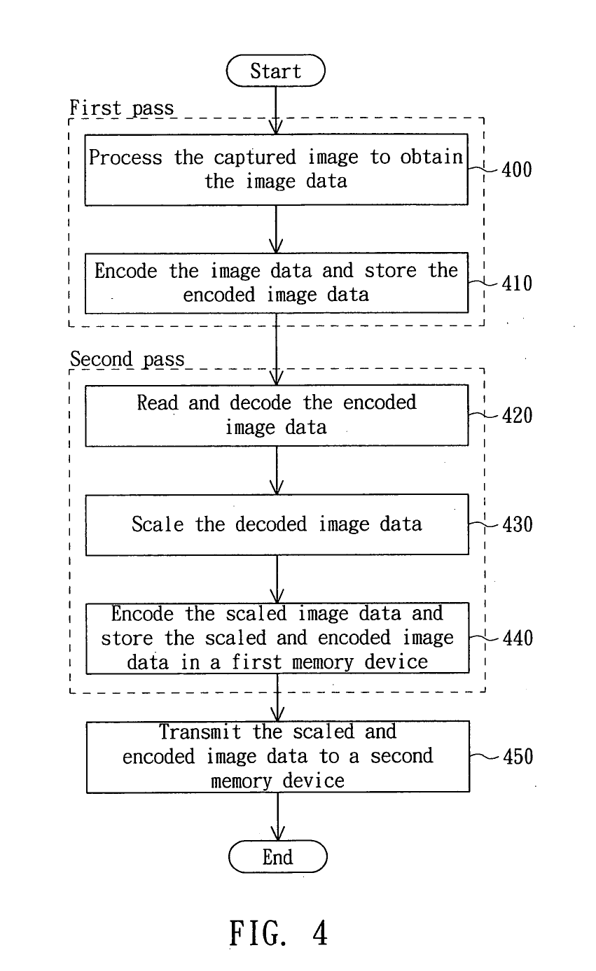

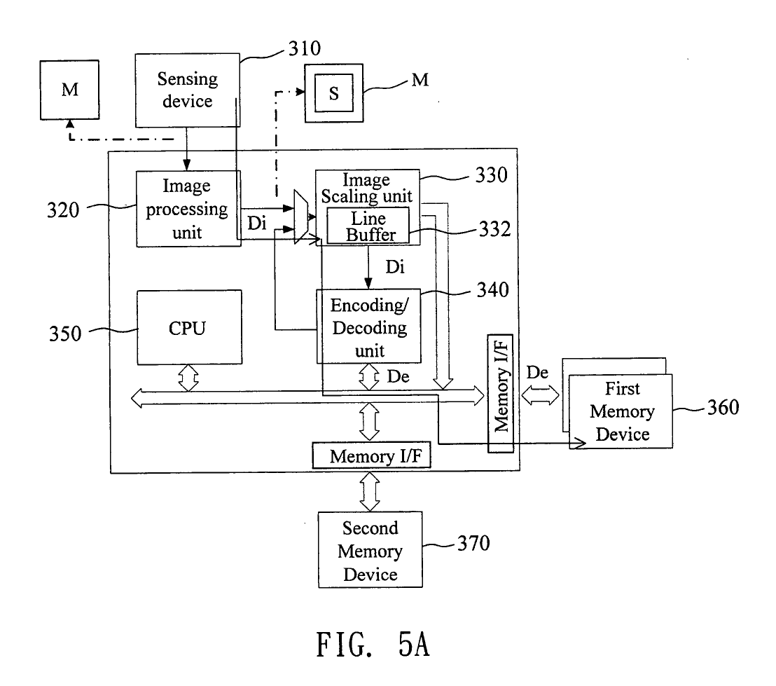

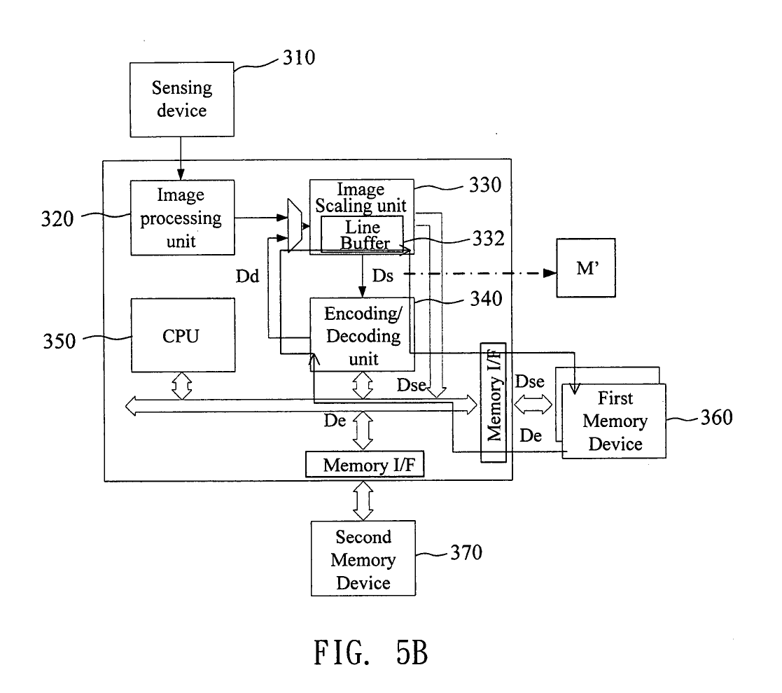

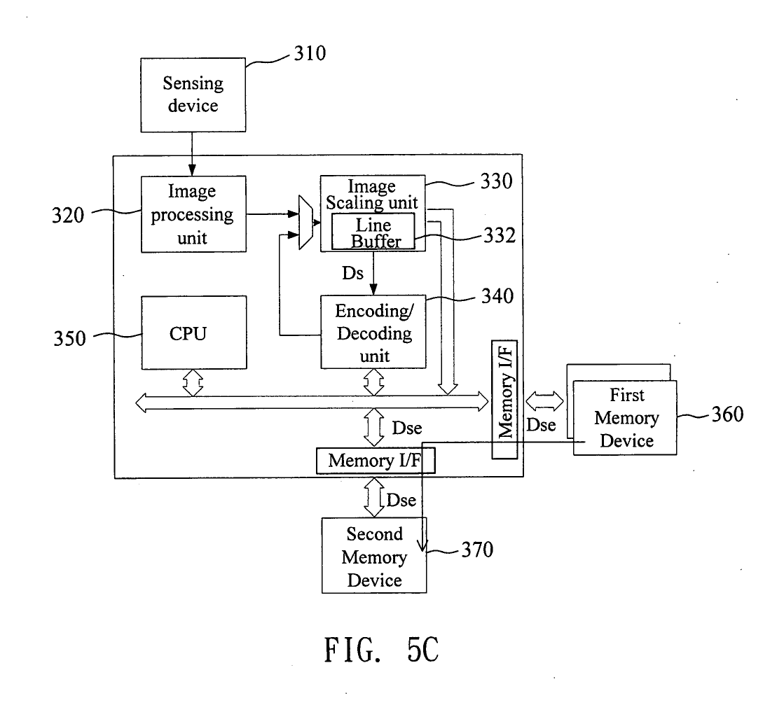

Referring to FIG. 4, a flow chart of the method for image capturing according to the preferred embodiment of the invention is shown. First, a first pass of operation is performed. In step 400, process the captured image M to obtain the image data Di. In this step, it can be designed that only a portion of the image M, such as a zoom-in area S of the image M, is processed. As shown in FIG. 5A, the ISP 320 performs an image processing on the image M captured by the sensing device 310 and outputs the image data Di. In preferred embodiment, the image data Di may be corresponding to the zoom-in area S of the image M. Next, in step 410, encode the image data Di and store the encoded image data De. As shown in FIG. 5A, the image resizer 330 transmits the image data Di, without performing any scaling operation, directly to the encoding/decoding unit 340 for encoding, and the encoding/decoding unit 340 outputs the encoded image data De to the first memory device 360 for storage. The encoded image data De may be encoded to have a JPEG, JPEG2000, PNG, BMP, GIF, PCX, or TGA format for instance.

It can be designed that when the step 400 processes the captured image M completely, the step 410 can only encode a portion of the image data Di, which is corresponding to the zoom-in area S of the image M. It can also be designed that when the step 400 processes the captured image M completely and the step 410 also encodes the image data Di completely, only a portion of the encoded image De, which is corresponding to the zoom-in area S of the image M, is stored in first memory device 36.

In summary, in the first pass of operation, only a portion of the image, namely the zoom-in area S of the image M, is stored in the first memory device. In a preferred embodiment, the step 400 processes a portion of the image, and therefore, only the portion of the image is encoded and stored.

Afterwards, a second pass of operation is performed. In step 420, read the encoded image data De from the memory device 360 and decode the image data De. As shown in FIG. 5B, the CPU 350 reads the encoded image data De from the first memory device 360 and transmits the image data De to the encoding/decoding unit 340 for decoding. The encoding/decoding unit 340 decodes the image data De and outputs the decoded image data Dd. Next, in step 430, scale the decoded image data Dd. As shown in FIG. 5B, the image resizer 330 enlarges the image data Dd to the image M′ having the same scale as the image M, and outputs the scaled image data Ds. The image resizer 330 can use an interpolation method to magnify the decoded image data Dd. Following that, in step 440, encode the scaled image data Ds and store the scaled and encoded image data Dse. As shown in FIG. 5B, the encoding/decoding unit 340 encodes the scaled image data Ds again and outputs the scaled and encoded image data Dse to the first memory device 360 for storage. It is noted that the encoding/decoding unit 340 can use a half-duplex or a full-duplex method to encode the image data Dse and decode the image data De. Finally, in step 450, transmit the image data Dse stored in the first memory device 360 to the second memory device 370 by the CPU 350 as shown in FIG. 5C.

As mentioned above, during the first pass of operation, a portion of the image M is stored without being scaled, and the scaling operation is then performed during the second pass of operation. The CPU 350 can control the rate of reading data from the first memory device 360, and therefore can control the timing of inputting the encoded image data to the image scaling unit 330, for example, it can be designed that only after the image scaling unit 330 has finished the scaling operation on the previous inputted data, will the CPU read the next-to-be-handled data from the first memory device 360 to be transmitted to the encoding/decoding unit 340 for decoding and then to the image scaling unit 330 for scaling. Thus, the image scaling unit 330 can process the decoded image data Dd without any data loss.

Besides, during the first pass of operation, the image data is encoded by the encoding/decoding unit 340 before being storing in the first memory device 360, so the required memory space for storing the image data is reduced.

According to the present invention, the zoom-in image data is stored without being scaled during the first pass of operation. The scaling operation is performed during the second pass of operation so that the image scaling unit has enough time to scale the image data without any data loss. Moreover, the image data is compressed before being stored in the memory device. Therefore, the required memory space for storing image data can be reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An apparatus for image capturing, comprising:
a sensing device, for capturing an image;
an image processing unit, for processing the captured image;
a memory device, for storing a portion of the image;
an image scaling unit, for scaling the portion of the image; and
a central processing unit, wherein after the image processing unit processes the image, only the portion of the image is stored in the memory device, the central processing unit controls reading data of the portion of the image stored in the memory device and transmission of the data to the image scaling unit for image scaling so as to output a scaled image for the portion of the image.

2. The apparatus according to claim 1, wherein the sensing device comprises a charge coupled device (CCD) or a complimentary metal oxide semiconductor (CMOS) sensor.

3. The apparatus according to claim 1, wherein the image processing unit is an image signal processor (ISP).

4. The apparatus according to claim 1, wherein the portion of the image is a zoom-in area of the image, and the image scaling unit is for enlarging the zoom-in area of the image to a predetermined scale.

5. The apparatus according to claim 1, wherein the image scaling unit comprises a line buffer for storing image data to be referred during scaling.

6. The apparatus according to claim 1, further comprising an encoding/decoding unit, coupled to the image processing unit, for encoding the processed image, and then outputting the encoded image into the memory device for storing.

7. The apparatus according to claim 6, wherein the encoding/decoding unit is further for decoding the portion of the image stored in the memory device and transmitting the decoded portion of the image to the image scaling unit for scaling.

8. The apparatus according to claim 6, wherein the encoding/decoding unit is a half-duplex or a full-duplex JPEG codec.

9. The apparatus according to claim 8, wherein the image scaling unit scales the decoded portion of the image and outputs the scaled portion of the image to the encoding/decoding unit for encoding, and then the encoding/decoding unit encodes the scaled portion of the image and outputs the scaled and encoded portion of the image to the memory device for storing.

10. The apparatus according to claim 1, wherein the memory device comprises a NOR flash and random access memory (RAM).

11. A method for image capturing, comprising:
capturing an image;
processing the image;
storing a portion of the image in a memory device; and
reading data of the portion of the image stored in the memory device and transmitting the data to an image scaling unit for scaling the portion of the image so as to output a scaled image for the portion of the image.

12. The method according to claim 11, wherein before the step of storing the portion of the image, the method further comprises the step of encoding the image; and before the step of scaling the portion of the image, the method further comprises the step of decoding the portion of the image.

13. The method according to claim 12, wherein after the step of scaling the portion of the image, the method further comprises the step of encoding the portion of the image.

14. The method according to claim 12, wherein the portion of the image is encoded to have a JPEG, JPEG2000, PNG, BMP, GIF, PCX, or TGA format.

15. The method according to claim 11, wherein the portion of the image is a zoom-in area of the image.

16. The method according to claim 15, wherein in the step of scaling the portion of the image, the zoom-in area is enlarged to have a predetermined scale.

17. The method according to claim 13, wherein the steps of decoding and encoding are performed by a half duplex or a full duplex method.

18. The method according to claim 11, wherein after the step of scaling the portion of the image, the method further comprises the step of storing the scaled portion of the image.

19. The apparatus for image capturing according to claim 1, wherein the central processing unit controls reading the data of the portion of the image and transmission of the data to the image scaling unit according to status of operation of the image scaling unit.

20. The method for image capturing according to claim 11, wherein reading the data of the portion of the image and transmitting of the data to the image scaling unit are controlled according to status of operation of the image scaling unit.
